(19) United States
(12) Patent Application Publication
(10) Pub. No.: US 2019/0380519 A1
(43) Pub. Date: Dec. 19, 2019

(54) EDIBLE EATING DEVICE AND METHOD OF MAKING

(71) Applicant: Savorware, LLC, Atlanata, GA (US)

(72) Inventors: Mehul Bhagat, Suwanee, GA (US); Rostam Zafari, Decatur, GA (US)

(21) Appl. No.: 16/437,980

(22) Filed: Jun. 11, 2019

Related U.S. Application Data
(60) Provisional application No. 62/686,233, filed on Jun. 18, 2018.

(51) Int. Cl. A47G 21/04; A23P 30/10

(52) U.S. Cl. CPC A47G 21/04; A47G 2400/105; A23P 30/10

(57) ABSTRACT

A composition for use in an edible eating device such as a spoon is provided. The composition comprises a blend of flours comprising gluten flour and non-gluten flour, and a liquid. A method of making an edible eating device is provided. The method comprises providing a composition in a form of a dough comprised of a liquid and a blend of flours comprising gluten flour and non-gluten flour, and molding the composition into a three-dimensional curved-shaped, edible eating device. The eating device comprises a composition comprised of a liquid and a blend of flours comprising gluten flour and non-gluten flour. The eating device is in a three-dimensional shape and is edible and biodegradable.

### CROSS-REFERENCE TO RELATED APPLICATIONS

This application claims priority from U.S. Provisional Patent Application No. 62/686,233, filed on Jun. 18, 2018, in the United States Patent and Trademark Office. The disclosure of which is incorporated herein by reference in its entirety.

### FIELD OF THE INVENTION

The present invention relates to the field of eating devices, particularly edible eating devices and methods of making.

### BACKGROUND OF THE INVENTION

Single-use plastic such as plastic bags, straws, and stirrers, among others, are used for seconds, minutes, or hours but often ultimately reside in landfills and oceans. Concerns have been raised in the public that plastic may leach toxic chemicals, contaminate the food chain, or break into microplastics (small plastic pieces less than five millimeters long) having an impact on marine life and human health. In the United States, it has been reported that over 40 billion pieces of plastic cutlery are used each year. The World Economic Forum reports that by 2050, the oceans will contain more plastic than fish.

There are currently two types of single-use spoons on the market. To be environmentally sustainable, a product needs to be produced with renewable resources and have sustainable options for end-of-life. For example, traditional plastic does not biodegrade and is not made from renewable resources as it is derived from oil. Compostable materials are sometimes made from renewable resources (such as corn) but do not biodegrade.

Recycling often proves inefficient as about 70% of plastic bottles are not recycled, and all plastic that has ever been created exists in some form. Edible eating devices such as spoons, forks, and sporks are an alternative to plastic and compostable devices can be eaten and can quickly biodegrade if discarded. However, current attempts to produce such edible eating devices have resulted in products that quickly lose their structural integrity, contain high amounts of sugar, are expensive, or are inefficient to mass produce. Additionally, many formulations for edible tableware are not conducive to large-scale production. Attempts to create biodegradable polymers out of lignin and glycix are not cost-effective and have only been synthesized in small quantities, particularly in lab settings.

Thus, there is a need for a process that produces eating devices that are edible, biodegradable, made from renewable resources, mass producible and cost-effective.

### SUMMARY OF THE INVENTION

In an embodiment of the invention, a composition suitable for being formed into a three-dimensional edible device is provided.

In an embodiment of the invention, a method of making the three-dimensional edible device is provided.

In an embodiment of the invention, the three-dimensional edible eating device is in a form of a food handling utensil such as a spoon, a spork, a fork, a knife, chopsticks, a straw, a plate, a cup, a bowl, among others configurations.

Further areas of applicability of the present invention will become apparent from the detailed description provided hereinafter. It should be understood that the detailed description and specific examples, while indicating the preferred embodiments of the invention, are intended for purposes of illustration only and are not intended to limit the scope of the invention.

### BRIEF DESCRIPTION OF THE DRAWINGS

The present invention will become more fully understood from the detailed description and the accompanying drawings, which are not necessarily to scale, wherein:

FIG. 1 is a photograph of an edible eating device in a form of a spoon in accordance with the present invention.

FIG. 2 is a photograph of an edible eating device in a form of a spoon in accordance with the present invention.

FIG. 3A is a perspective view of a spoon illustrating length of the spoon.

FIG. 3B is a perspective view of a spoon illustrating width of the spoon.

FIG. 4A is a perspective view of a soup spoon illustrating length of the soup spoon.

FIG. 4B is a perspective view of a soup spoon illustrating width of the soup spoon.

FIG. 5 illustrates of a bottom view of a Computer-Aided Design (CAD) spoon mold.

FIG. 6 is a perspective view of a CAD soup spoon.

FIG. 7 is a schematic of a specimen under loading.

FIG. 8 is a Force-Displacement graph for the chocolate specimen (sample 1).

FIG. 9 is a Force-Displacement graph for the chocolate specimen (sample 2).

FIG. 10 is a Force-Displacement graph for the chocolate specimen (sample 3).

FIG. 11 is a Force-Displacement graph for the plain specimen (sample 1).

FIG. 12 is a Force-Displacement graph for the plain specimen (sample 2).

FIG. 13 is a Force-Displacement graph for the plain specimen (sample 3).

FIG. 14 is a Force-Displacement graph for a tomato basil flavored specimen.

FIG. 15 is a graph illustrating percentage (%) of water absorption over time for different samples.

### DESCRIPTION OF THE PREFERRED EMBODIMENTS

The following description of the embodiments of the present invention is merely exemplary in nature and is in no way intended to limit the invention, its application, or uses. The present invention has broad potential application and utility, which is contemplated to be adaptable across a wide range of industries. The following description is provided herein solely by way of example for purposes of providing an enabling disclosure of the invention, but does not limit the scope or substance of the invention.

In an embodiment of the invention, a composition suitable for being formed into a three-dimensional edible eating device, also referred to interchangeably as a three-dimensional edible food handling device, is provided. The three-dimensional edible eating device of the present invention is preferably grain-based and/or flour-based. Grain-based refers to any composition derived from a grain, defined by dictionary.com as a “small, hard seed, especially the seed of a plant such as wheat, corn, rye, oats, or millet.” Flour-based refers to any composition derived from a flour, defined by dictionary.com as a “product consisting of finely milled wheat; also: a similar product made from another grain or food product.”

In an embodiment of the invention, the composition comprises flour and a liquid. Preferably, the liquid is water. Preferably, the composition comprises a blend of flours. Non-limiting examples of types of flour include, but are not limited to, rice flour, wheat flour, millet flour, sweet sorghum flour, cake flour, white bread flour, barley flour, all-purpose flour, amaranth flour, white rice flour, arrowroot flour, potato flour, potato starch flour, almond flour, corn flour, self-rising flour, and a combination thereof. Preferably, the flour is organic. Preferably, the wheat flour is a whole wheat flour.

With regard to the use of the flour, a ratio of gluten flour (protein bonds/matrix) to non-gluten flour is selected to ensure the structural integrity of the final product. The ratio may vary based on choice of flour as each flour has its own material properties. A non-limiting example of an effective ratio of non-gluten flour to gluten flour is 1.5 to 3 (non-gluten):1 (gluten).

The flour blend needs to have an appropriate balance between extensibility (how far the dough stretches) and elasticity (how quickly it returns to its original shape). Non-limiting examples of non-gluten flours include, but are not limited to, rice flour, millet flour, sweet sorghum flour, cake flour, barley flour, amaranth flour, white rice flour, arrowroot flour, potato flour, potato starch flour, almond flour, corn flour, gluten-free self-rising flour. Non-limiting examples of gluten flours include, but are not limited to, cake flour, white bread flour, all-purpose flour, self-rising flour.

The composition may further comprise other components including, but not limited to, flavorings (wet and/or dry), colorants, vital wheat gluten, oil, xanthan gum, ascorbic acid, salt, sugar, powders (such as cocoa powder), preservatives (including natural preservatives, such as ascorbic acid and rosemary oil).

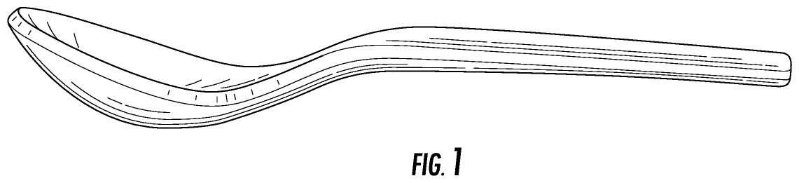

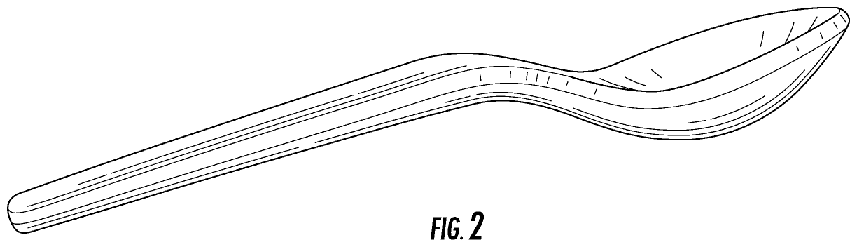

Non-limiting examples of flavorings include, but are not limited to, honey, vanilla, chocolate, maple, fruit, nut milks, coconut milk, cold-pressed juices, juice, juice concentrate, cane juice, milk, rice syrup, tapioca syrup, agave (syrup or nectar), golden syrup, malt syrup, any alcohol, caffeinated coffee, decaffeinated coffee, rose syrup, palm honey. FIG. 1 is a photograph of an edible eating device in a form of a spoon having a honey-vanilla flavor in accordance with the present invention. FIG. 2 is a photograph of an edible eating device in a form of a spoon having a dark chocolate flavor in accordance with the present invention.

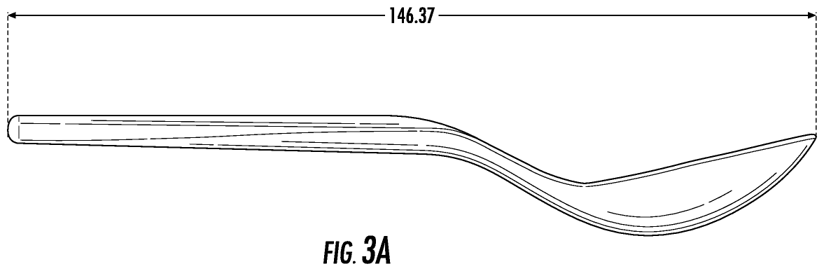

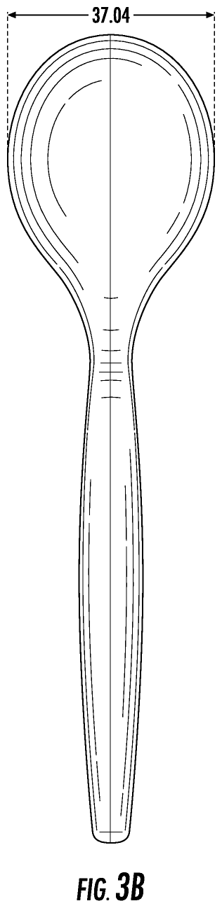

FIG. 3A is a perspective view of a spoon illustrating length of the spoon. FIG. 3B is a perspective view of a spoon illustrating width of the spoon with dimensions shown in millimeters (mm).

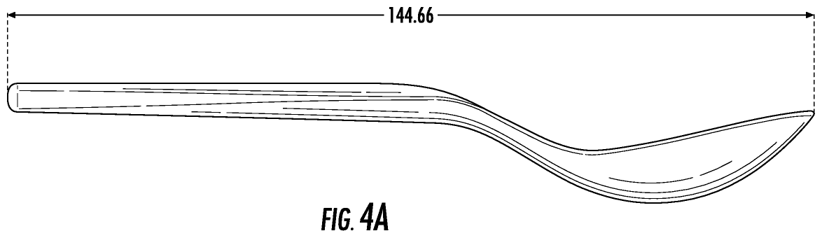

FIG. 4A is a perspective view of a soup spoon illustrating length of the soup spoon. FIG. 4B is a perspective view of a soup spoon illustrating width of the soup spoon with dimensions shown in millimeters.

In an embodiment of the invention, a method of making the three-dimensional edible device such as a spoon is provided.

The method generally comprises obtaining the components of the composition in accordance with the present invention, mixing together the flours and any other dry ingredients. Salt and sugar can be used to enhance taste. Powders or other dry flavorings, such as cocoa powder, can be added to alter the taste of the edible device.

After dry ingredients are mixed together, the method comprises adding water to the mixture to form a dough and kneading the dough. A food mixer can be used to assist in ensuring that the dough receives even amounts of water. Kneading can be done by hand or by machine. Kneading of the dough occurs to ensure the gluten forms a protein matrix and improves the structural integrity of the baked product. Overkneading (generally 15+minutes) can lead to cracks in the spoon during the heating process and under kneading creates brittle spoons.

The method may comprise adding any other edible liquid to the dry ingredients, such as maple syrup or agave syrup. Other liquids or flavorings may be substituted for water.

The method comprises rolling the dough. The dough is rolled into a sheet of a desired thickness such as approximately three (3) cm to seven (7) cm thick. Rollers can assist in making sure that the dough is a uniform thickness. After rolling, cutting of the sheet into the desired two dimensional shape occurs. Any shape can be cut. Excess dough is recycled and reused.

The method comprises inserting the shaped dough pieces in a mold having a top and a bottom and molding the dough to form a three-dimensionally shaped object or device. Preferably, the dough is compression molded to create the three-dimensional shape. In the case of a spoon, for example, the spoon has a three-dimensional curved shape.

Previous attempts to mold spoons resemble spatulas rather than spoons. Typical food manufacturing processes develop products with at least one flat side (Oreos, Animal Crackers, etc.). The edible spoon of the present invention has a significant curve between the handle and the head, resembling the plastic spoon it replaces.

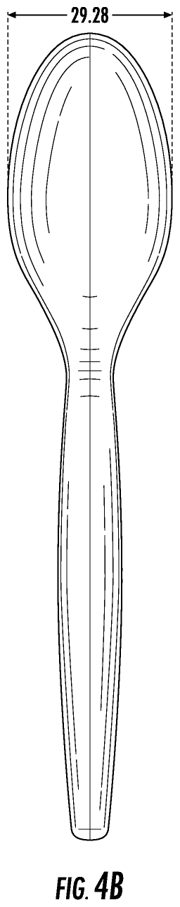

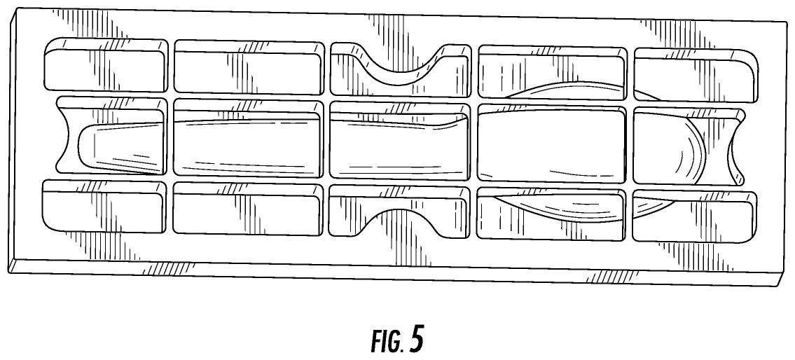

For example, the mold can be produced by using a single cavity CNC (Computer Numerical Control) mold in a standard convection oven. The molding process of the present invention is compatible with other machining technologies involved in the production of baked goods, such as tunnel ovens, cooling racks, and conveyor belts. The mold itself can be produced by any method(s) known to those skilled in the art. Preferably, the mold is designed for producing a three-dimensional shaped eating utensil such as a spoon, a spork, a fork, or a straw. FIG. 5 illustrates of a bottom view of a Computer-Aided Design (CAD) spoon mold. FIG. 6 is a perspective view of a CAD soup spoon.

The method comprises removing flash which is excess dough from the mold before the dough hardens. The exact temperature and cycle time for manufacturing the product may vary depending upon the final composition of the dough. For example, spoons are baked at a temperature range of from 315 Fahrenheit to 475 Fahrenheit for a duration of 12 minutes to 25 minutes. However, a low percentage of water (typically less than 10%) is necessary to ensure that the final object or device has an appropriate shelf-life.

In an embodiment of the invention, the three-dimensional edible device is comprised of the composition of the present invention and is useful for eating and/or drinking. The device of the present invention is an edible, biodegradable, three-dimensional, molded food product that is also an eating and/or drinking device. The device may be in the form of tableware including, but not limited to, spoons, soup spoons, sporks, forks, knives, chopsticks, and plates, among others configurations. The composition can be used in the manufacture of other edible, biodegradable devices including, but not limited to, straws and cups.

The edible device of the present invention is more sustainable as compared to compostable single-use products and traditional plastic. The present invention does not rely on creating a composting infrastructure for sustainable disposal.

The edible device of the present invention has a nutritional profile that is marketable to a wide consumer audience as the edible device of the present invention has lower amounts of sugar than edible cups from seaweed which, for example, have resulted in products with upwards of 15 g of sugar in a single unit and a significant amount of protein (such as between 2 g to 4 g per spoon). The tableware of the present invention can contain up to 80% protein by mass depending on the type of edible eating/drinking device.

The device of the present invention can be molded into a three-dimensional shape without losing its structural integrity when used with hot and cold liquids. The product is durable and lasts in hot liquids but is soft enough to eat. The structural integrity of the edible device of the present invention mimics the form and function of the plastic eating devices that it replaces. The spoon can last a minimum of 20 minutes in 70 degrees Celsius (158 degrees Fahrenheit) water and maintain good usage (invariance, non-deformation, it lasts at minimum 20 minutes in ice cream, which has an average temperature of 6 to 10 degrees Fahrenheit or −14.4 to −12.2 degrees Celsius.

Unlike compostable products and traditional plastics, the device of the present invention is made from renewable resources and is biodegradable and, for example, may biodegrade in a matter of weeks. The edible device of the present invention fulfills a sustainable closed-loop. The edible device of the present invention is produced with renewable resources and can be disposed of sustainably.

The edible device of the present invention can be eaten as a snack or is disposable by known methods of waste disposal.

### Example 1

An edible eating device in a form of a spoon was prepared according to the following method.

As described, ⅓ cup whole wheat flour, ⅓ cup of organic brown rice flour, and ⅓ cup of organic millet flour, tsp table salt, ¼ teaspoon xanthan gum, ⅛ tsp of ascorbic acid, and 1 tsp of vital wheat gluten were poured into a mixing bowl. These measurements were used to produce 4 or 5 spoons depending upon the size and shape of the mold as well as the thickness of the spoon. Any flavorings were added at this stage.

Approximately 6.5 tbsp of water were added to the flour mixture, 1 tbsp at a time, while mixing the dough. The water was added incrementally to ensure that the dough was being mixed evenly while the water and flour reacted. The dough was moist, but smooth. Although a food mixer can be used, the dough was mixed by hand in this example.

The dough was kneaded for 5 minutes by hand. This created a protein mixture pattern in the dough and strengthened the gluten bonds that make strength in the final product.

The dough sat for approximately 45 minutes so the gluten bonds could firm up.

The dough was rolled through rollers (in 4 stages) into a sheet 0.5 cm (5 mm) thick.

A plastic die-cut was used to cut out the dough in the shape of the mold. The insides of the mold were coated with vegetable oil to prevent sticking.

The dough (5 mm thick) was clamped with the top and bottom spoon mold. The mold was opened and any excess flash was cut out.

The mold was closed and clamped with four 2-inch McMaster clamps. The dough for the spoon was sandwiched: a bottom mold, a thin layer of dough, and a top mold. The mold sealed the dough spoon into place and prevented it from expanding during the heating process. It also safeguarded the spoon from movement during baking. The clamps exerted pressure of approximately 800 lbs to ensure that the spoon is baked into shape.

The spoon mold was placed in a preheated convection oven at 425 degrees Fahrenheit for 3 minutes. The convection oven was used to ensure even spread of the dough during the baking process. The mold was removed, the clamps were removed, and the mold was opened. Any final flashes were cut out.

The spoon and mold were placed (without clamps) into a convection oven at 350 degrees Fahrenheit for twenty minutes. The lower bake time allowed the spoon to harden. Time spent out of the oven was minimized so that energy was used to bake the spoon.

The spoon and mold were placed (without clamps) into the final baking stage in a convection oven at 170 degrees Fahrenheit for 5 minutes. This allowed the spoon to assume a uniform coloring and harden in the final stages of bake.

The spoon was removed from the mold and allowed to cool to room temperature. This took approximately 20 minutes. The spoon was cooled to harden.

The spoon was packaged to preserve freshness. The length and weight of one of the finished product spoons was 5.5 inches and 10 g, respectively.

TABLE 1
Sources of components

Water
Swarna Whole Wheat Flour (Stone Milled)
Red Mill Organic Brown Rice Flour
Red Mill Organic Millet Flour
Vital Wheat Gluten
Vegetable oil
Xanthum Gum
Ascorbic Acid
Table salt

TABLE 2
Composition of Spoon:

| | | | |
|---|---|---|---|
| Water | 6.5 | tbsp | 28.00% |
| Whole wheat flour | ⅓ | cup | 22.98% |
| Organic brown rice flour | ⅓ | cup | 22.98% |
| Organic millet flour | ⅓ | cup | 22.98% |
| Vital wheat gluten | 1 | tsp | 1.44% |
| Vegetable oil | ½ | tsp | 0.72% |
| Xanthan gum | ¼ | tsp | 0.36% |
| Salt | ¼ | tsp | 0.36% |
| Ascorbic acid | ⅛ | tsp | 0.18% |
| Total | 1.45 | cups | 100% |

### Example 2

A 3-Point Bend Test (which is a common materials test and involves a wide range of loads) was conducted. Samples were supported on each end while a load was applied to its middle (3 Point Bend). Data was retrieved from the test.

This test output a Force-Displacement curve. At the moment of break, there is a drop in the applied force as there is no more resistance. FIG. 7 shows a schematic of a specimen under loading P at point B. The sample has end points A and C, and a middle point B. The sample or specimen has a Length L and dimensions b and d as shown.

The maximum flexural stress of that can be applied to the specimen was determined by the following equation:

$${σ}_{f} = \frac{3 {P}_{max} L}{2 {bd}^{ 2}}$$

Where Pₘₐₓ is the maximum load before breaking down, L is the length of the specimen, b is the width of the specimen, d is the thickness of the specimen.

The results were as follows:

Chocolate Sample 1: Pₘₐₓ=23.1 N σ_{f}=4.466372 (N/mm)

Chocolate Sample 2: Pₘₐₓ==23.4 N σ_{f}=4.473628 (N/mm)

Chocolate Sample 3: Pₘₐₓ=25.1 N σ_{f}=4.874171 (N/mm)

Mean=23.86 N, Variance=0.775

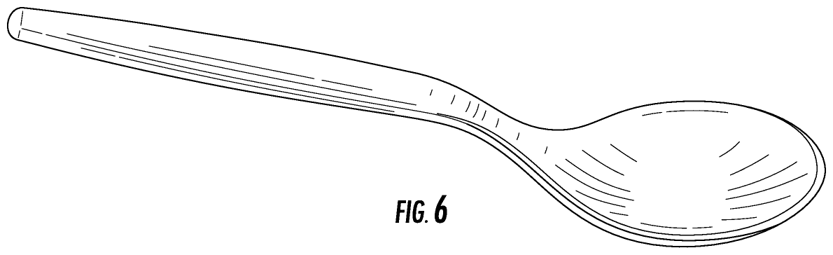

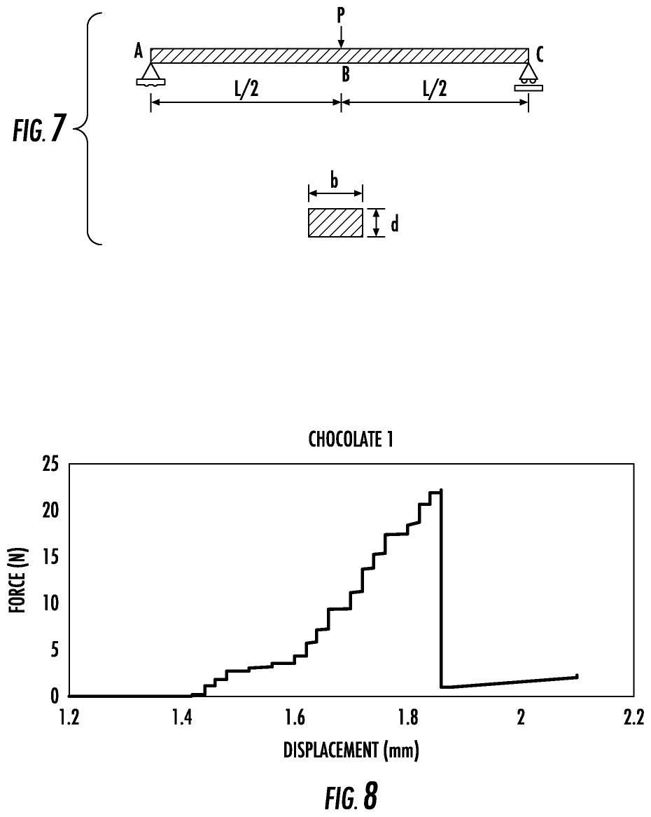

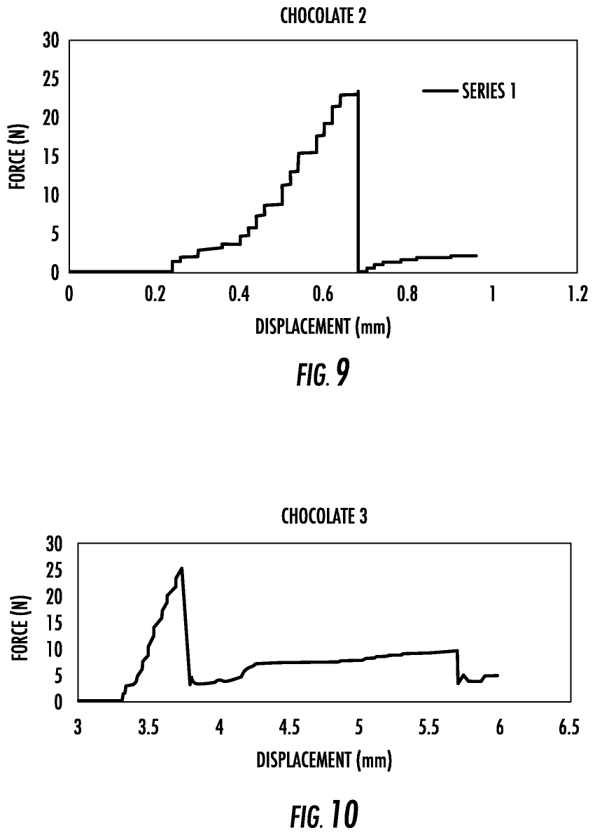

FIGS. 8, 9 and 10 show the Force-Displacement graphs for the three specimens. FIG. 8 is a Force-Displacement graph for the chocolate specimen (sample 1). FIG. 9 is a Force-Displacement graph for the chocolate specimen (sample 2). FIG. 10 is a Force-Displacement graph for the chocolate specimen (sample 3).

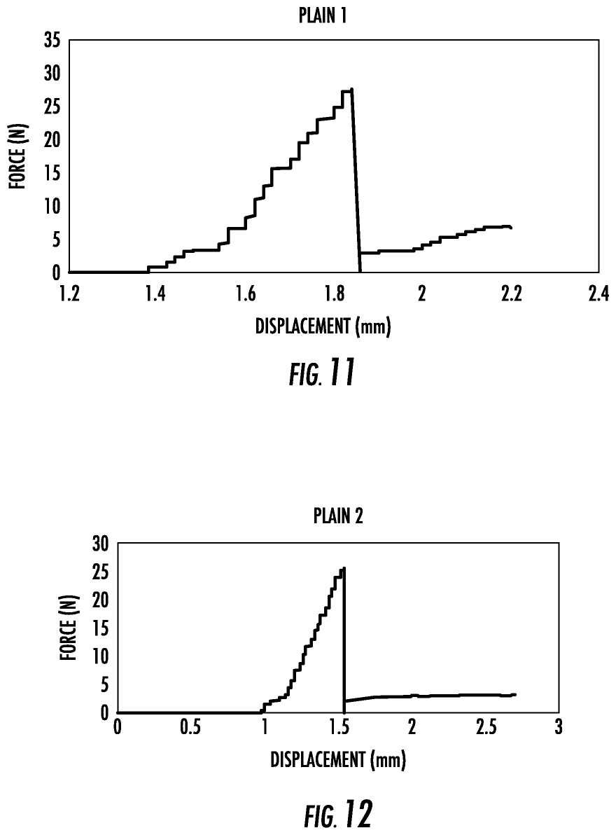

Plain specimens were tested. FIG. 11 is a Force-Displacement graph for the plain specimen (sample 1). FIG. 12 is a Force-Displacement graph for the plain specimen (sample 2). FIG. 13 is a Force-Displacement graph for the plain specimen (sample 3).

Plain Sample 1: Pₘₐₓ=28.14 N σ_{f}=5.437322 (N/mm)

Plain Sample 2: Pₘₐₓ=24.5 N σ_{f}=4.757657 (N/mm)

Plain Sample 3: Pₘₐₓ=26.14 N σ_{f}=5.126618 (N/mm)

Mean=26.26 N, Variance=2.215

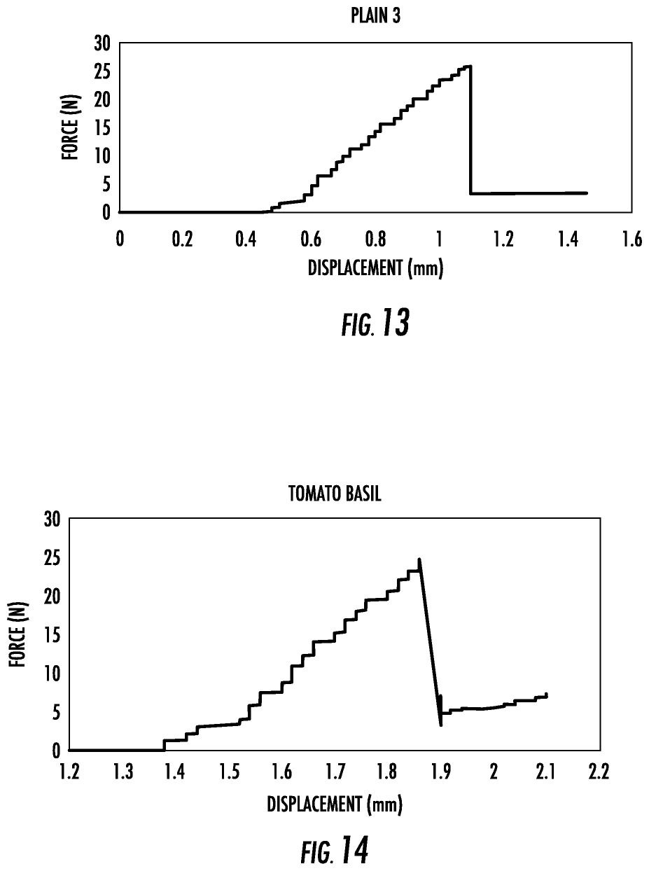

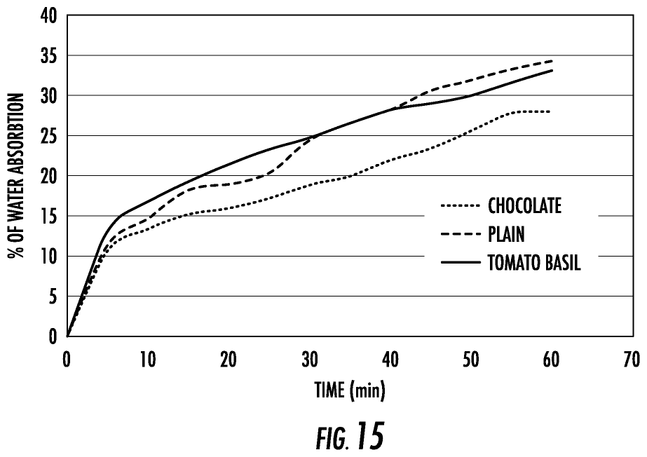

A flavored specimen having a tomato basil flavor was tested. FIG. 14 is a Force-Displacement graph for the tomato basil specimen.

Tomato Basil Sample: Pₘₐₓ=25.31 N σ_{f}=4.854752 (N/mm)

Results show that the maximum applied force was in a range of 23N to 28 N in the middle of the specimen with a length of 4 cm.

### Example—Water Absorption Test

Water absorption tests were conducted. Samples were weighted at the beginning, then, they were put in water and they were weighted in every 5 minutes to calculate the amount of water they absorb through time.

Table 3 shows the achieved results:

| | | 5 | 10 | 15 | 20 | 25 | 30 | 35 | 40 | 45 | 50 | 55 | 60 |
|---|---|---|---|---|---|---|---|---|---|---|---|---|---|
| Specimen | Dry | min | min | min | min | min | min | min | min | min | min | min | min |
| Chocolate | 5.47 | 6.05 | 6.2 | 6.3 | 6.34 | 6.41 | 6.5 | 6.56 | 6.67 | 6.75 | 6.87 | 6.99 | 7 |
| Plain | 5.11 | 5.69 | 5.86 | 6.04 | 6.08 | 6.15 | 6.36 | 6.46 | 6.55 | 6.67 | 6.74 | 6.81 | 6.86 |
| Tomato | 4.9 | 5.54 | 5.72 | 5.84 | 5.95 | 6.04 | 6.11 | 6.2 | 6.28 | 6.32 | 6.37 | 6.45 | 6.52 |
| Basil | | | | | | | | | | | | | |

FIG. 14 is a graph illustrating percentage (%) of water absorption over time for different samples.

According to FIG. 14, the chocolate samples reacted better in water and absorbed less water compared to the plain and tomato basil samples.

It will therefore be readily understood by those persons skilled in the art that the present invention is susceptible of broad utility and application. Many embodiments and adaptations of the present invention other than those herein described, as well as many variations, modifications and equivalent arrangements, will be apparent from or reasonably suggested by the present invention and the foregoing description thereof, without departing from the substance or scope of the present invention. Accordingly, while the present invention has been described herein in detail in relation to its preferred embodiment, it is to be understood that this disclosure is only illustrative and exemplary of the present invention and is made merely for purposes of providing a full and enabling disclosure of the invention. The foregoing disclosure is not intended or to be construed to limit the present invention or otherwise to exclude any such other embodiments, adaptations, variations, modifications and equivalent arrangements.

What is claimed is:

1. A composition comprising:
a blend of flours comprising gluten flour and non-gluten flour, and
a liquid,
wherein the composition is in a form of a three-dimensional eating device.

2. The composition according to claim 1, wherein the non-gluten flour is in a ratio to gluten flour of 1.5 to 3 (non-gluten):1 (gluten).

3. The composition according to claim 1, wherein the non-gluten flour is selected from the group consisting of, rice flour, rice flour, millet flour, sweet sorghum flour, cake flour, barley flour, amaranth flour, white rice flour, arrowroot flour, potato flour, potato starch flour, almond flour, corn flour, gluten-free self-rising flour, and a combination thereof.

4. The composition according to claim 1, wherein the gluten flour is selected from the group consisting of cake flour, white bread flour, all-purpose flour, self-rising flour, and a combination thereof.

5. The composition according to claim 1, wherein the liquid is water.

6. The composition according to claim 1, wherein the composition further comprises a component selected from the group consisting of flavorings, colorants, vital wheat gluten, oil, xanthan gum, ascorbic acid, salt, sugar, powders, preservatives, and a combination thereof.

7. A composition comprising:
water,
whole wheat flour,
rice flour,
millet flour,
wheat gluten,
vegetable oil,
xanthum gum,
ascorbic acid, and
salt,
wherein the composition is in a form of a three-dimensional eating device.

8. A method of making an eating device, the method comprising:
providing an edible composition in a form of a dough comprised of a liquid and a blend of flours comprising gluten flour and non-gluten flour, and
molding the edible composition into a three-dimensional eating device.

9. The method according to claim 8, wherein the non-gluten flour is present in a ratio to gluten flour of 1.5 to 3 (non-gluten):1 (gluten).

10. The method according to claim 8, wherein the dough is kneaded prior to molding.

11. The method according to claim 8, wherein the three-dimensional eating device is in a form of a food handling utensil selected from the group consisting of a spoon, a spork, a fork, a knife, chopsticks, a straw, a plate, a cup, a bowl, and a combination thereof.

12. The method according to claim 8, further comprising baking the molded composition at a temperature in a range of from 315 Fahrenheit and 475 Fahrenheit.

13. The method according to claim 12, wherein the molded composition is baked for a duration of 12 minutes to 25 minutes.

14. The method according to claim 8, further comprising applying an applied force in a range of 23N to 28 N to a middle of the eating device.

15. An eating device comprising:
a composition comprised of a liquid and a blend of flours comprising gluten flour and non-gluten flour,
wherein the eating device is in a three-dimensional shape.

16. The eating device according to claim 15, wherein the eating device is edible.

17. The eating device according to claim 15, wherein the eating device is biodegradable.

18. The eating device according to claim 15, wherein the liquid is water.

19. The eating device according to claim 15, wherein the composition further comprises a component selected from the group consisting of flavorings, colorants, vital wheat gluten, oil, xanthan gum, ascorbic acid, salt, sugar, powders, preservatives, and a combination thereof.

20. The eating device according to claim 15, wherein the eating device is water absorbent.
